(19) United States
(12) Patent Application Publication
(10) Pub. No.: US 2005/0191392 A1
(43) Pub. Date: Sep. 1, 2005

(54) Methods for inhibiting bacterial growth in raw meat and poultry

(76) Inventor: Richard Hull, Jefferson, GA (US)

Correspondence Address: MCDERMOTT WILL & EMERY LLP, 600 13th Street, N.W., Washington, DC, 20005-3096, US

(21) Appl. No.: 10/958,652

(22) Filed: Oct. 6, 2004

Related U.S. Application Data
(60) Provisional application No. 60/509,416, filed on Oct. 7, 2003.

(51) Int. Cl. C12H 1/10

(52) U.S. Cl. 426/321

(57) ABSTRACT

The invention provides compositions and methods for treating raw meat to prevent bacterial growth, including Clostridium perfringens and Listeria, on or in the meat. The compositions of the invention are applied to the surface of the meat, mixed into the meat or both to obtain antibacterial effect.

### RELATED APPLICATION

This application claims priority to U.S. Provisional Application 60/509,416, filed Oct. 7, 2003, which is incorporated herein in its entirety.

### FIELD OF THE INVENTION

The invention relates to methods for inhibiting the growth of bacteria, particularly gram positive bacteria, in and on raw meats and poultry, thereby extending the shelf life of the treated meats and poultry. In particular, the invention relates to the use of aqueous solutions containing about 50 to about 95% sodium citrate or potassium citrate and about 5% to about 50% sodium acetate, sodium diacetate or a combination thereof to treat raw meat and poultry.

### BACKGROUND OF THE INVENTION

In co-pending U.S. application Ser. No. 10/285,356, a method for treating cooked, ready-to-eat meats and poultry to inhibit bacterial growth is disclosed. In the method disclosed therein, cooked meats are treated with a buffered solution of sodium citrate, preferably that marketed under the name IONAL, in conjunction with sodium acetate or diacetate. The treatment of cooked meat products results in inhibition of the growth and germination of Clostridium perfringens.

The prior method involves incorporating into a meat product at any time, but preferably during the processing of the meat before it is cooked or packed, although incorporation during cooking is possible as well, a solution of buffered sodium citrate or potassium citrate, preferably IONAL and sodium acetate or sodium diacetate.

U.S. application Ser. No. 10/285,356 also discloses application of a highly concentrated solution of buffered citrate and sodium diacetate to the surface of cooked meat. A pick up concentration of the solution onto the surface of the cooked meat of about 1% of the weight of the meat to which the solution was applied was observed to decrease the bacterial count on the meat after several days storage at 4° C.

Other methods and compositions which utilize diacetate and acetate alone or in combination with ingredients such as lactates are also used to inhibit bacterial growth in meat. However, such compositions cause reduction in yield, off flavors, color degradation and excessive purge/brine loss during storage.

Thus, there remains a need for methods and compositions for treating raw meat and poultry to inhibit the growth of bacteria, particularly methods that do not significantly alter the pH of the meat product and do not require application of high concentrations of anti-bacterial compositions to the meat. There is also a need for methods of treating raw meat products that reduce purge (loss of water) and provide color retention of the meat during storage.

### BRIEF DESCRIPTION OF THE DRAWINGS

FIG. 1 is a graph showing the amount of bacteria (CFU/g) on raw pork and raw chicken treated at various times after treatment with Ional Plus and stored at 1° C.

FIG. 2 is a photograph of raw pork treated with Ional Plus at 26 days after treatment.

FIG. 3 is a graph showing the amount of bacteria (CFU/g meat) in tissue and in the purge of raw chickens marinated in a solution containing 0.55% Ional Plus (Formulation 1) or 0.75% Ional Plus (Formulation 2).

### SUMMARY OF THE INVENTION

In one aspect of the invention there is provided a method for treating raw meat comprising applying onto the surface of and/or in the raw meat an aqueous solution comprising about 50 to about 95% sodium citrate or potassium citrate and about 5 to about 50% diacetate, acetate or a combination thereof. In a preferred embodiment, a solution of about 75 to about 80% buffered citrate and about 20 to about 25% sodium acetate or sodium diacetate is applied to the surface of and/or in a raw meat or poultry product. In another preferred embodiment, the treated meat has a pick up of about 0.005% to 2% by weight of the solution to provide greater than 0.15% diacetate in and/or on the treated product. In another preferred embodiment of this aspect of the invention, a solution of about 75 to about 80% buffered potassium citrate and about 20 to about 25% potassium acetate, potassium diacetate or a combination thereof is applied to the surface of and/or on a raw meat or poultry product.

In another aspect of the invention there is provided a method for extending the storage stability of raw meat comprising treating the raw meat or raw poultry with a composition comprising about 75 to about 80% buffered citrate and about 20 to about 25% sodium acetate, potassium acetate, potassium diacetate, sodium diacetate or a combination thereof. In a preferred embodiment, the solution is applied to the surface of the raw meat. In another preferred embodiment, treatment of the meat with the solution of about 75 to about 80% buffered citrate and about 20 to about 25% sodium acetate, potassium acetate, potassium diacetate or sodium diacetate results in a pick up of about 0.005% to about 2% by weight of the solution.

In another aspect of the invention there is provided a raw meat product treated with a solution comprising about 75 to about 80% sodium citrate or potassium citrate, wherein the treated meat has a pick up of about 0.005% to about 2% by weight of the solution. In a preferred embodiment the solution comprises about 75 to about 80% buffered sodium citrate or buffered potassium citrate and about 20 to about 25% sodium or potassium diacetate, sodium or potassium acetate, or a combination thereof.

In yet another aspect of the invention there is provided a composition comprising about 75 to about 80% citrate by weight and about 20 to about 25% by weight sodium acetate, sodium diacetate or a combination thereof. In a preferred embodiment, the composition comprises about 75 to 80% buffered citrate and about 20 to about 25% sodium acetate, sodium diacetate, or a combination thereof.

In another aspect of the invention there is provided a composition comprising about 75% to about 80% citrate, preferably buffered citrate and about 20% to about 25% by weight potassium acetate or potassium diacetate.

In another aspect of the invention there is provided a method for retaining color of raw meat or raw poultry during storage comprising treating the raw meat or raw poultry with an aqueous solution comprising about 50 to about 95% sodium citrate or potassium citrate and about 5 to about 50% diacetate, acetate or a combination thereof. In a preferred embodiment, a solution of about 75 to about 80% buffered citrate and about 20 to about 25% sodium or potassium acetate, sodium or potassium diacetate, or a combination thereof is applied to the surface of a raw meat or poultry product. In another preferred embodiment, the treated raw meat or raw poultry has a pick up of about 0.005% to 2% by weight of the solution.

In a further aspect of the invention there is provided a method of reducing purge during storage of raw meat or raw poultry comprising applying a solution comprising about 50 to about 95% sodium citrate or potassium citrate and about 5 to about 50% diacetate or acetate to the raw meat or raw poultry. In a preferred embodiment, a solution of about 75 to about 80% citrate, preferably buffered citrate, and about 20 to about 25% sodium or potassium acetate or sodium or potassium diacetate is applied to the surface of a raw meat or poultry product. In another preferred embodiment, wherein the treated meat has a pick up of about 0.25% to 2% by weight of the solution

As used herein the term “raw meat” includes both raw meat and raw poultry unless otherwise indicated.

### DETAILED DESCRIPTION OF THE INVENTION

The present inventors have discovered that the storage stability of raw meats is significantly extended by treating the meat with an aqueous solution containing an effective amount of citrate, such as buffered citrate and an alkali metal or alkali earth metal of acetate or diacetate or a combination thereof. That is, treatment of raw meat with compositions and methods of the invention results in lower bacterial counts in the meat during storage, particularly gram positive bacteria including Listeria, in the treated meat compared to untreated raw meat, which extends the storage life of the raw meat. Further, it has been discovered that raw meat and poultry treated with the compositions and methods of the invention retain color and exhibit lower purge during storage than untreated meat.

The present inventors have also discovered that a broader range of anti-bacterial effect is achieved by treating meat, either raw or cooked meat, with an aqueous solution of sodium or potassium citrate and diacetate that results in greater than about 0.15% diactetate in the treated meat. Such treatment is shown to inhibit the growth of several gram positive bacteria, including Listeria, Staphylococcus and Clostridium.

The citrate used in the compositions of the invention may or may not be buffered. In one embodiment of the invention, the citrate is a citric acid buffered compound having a pH of about 5.6. In another preferred embodiment, the citrate is buffered with diacetate and/or acetate to achieve a pH of about 5.6. Similarly, the composition may contain sodium citrate or potassium citrate.

A typical composition used to treat the meat may consist of 50 to 95% by weight citrate, preferably sodium or potassium citrate, and 5 to 50% by weight sodium or potassium diacetate, sodium or potassium acetate or a combination thereof as active ingredients in water. The sodium citrate used in the composition may be buffered with organic acids such as citric acid, malic acid, succinic acid or acetic acid either alone or in combination at a pH of about 4.6 to about 7.6.

Optionally, other substances typically present in a marinade such as sodium acid pyrophosphate may be present, preferably in an amount of from about 0.25 to about 2% by weight.

In preferred embodiments of the invention, the composition contains about 20% by weight acetate, diacetate, or a combination thereof, most preferably sodium diacetate. A preferred composition of the invention comprises about 75 to about 80% buffered citrate and about 20 to about 25% sodium diacetate or sodium acetate. Preferably, the compositions of the invention are made as aqueous solutions.

Raw meat and poultry are treated with a composition of the invention by any means conventionally used to treat meat, such as, for example, immersion, injection, tumbling, drenching, spraying, or dipping of the raw meat in an aqueous solution. Thus, the aqueous composition may be applied to the surface of the meat or may be applied within the meat tissue or both. In one embodiment, a portion of the composition is injected into the meat, and the remainder of the composition is applied by massaging it into the meat in a tumbling operation, for example, or applied to the surface of the meat, by spraying or dipping for example. In another embodiment, one portion is worked into the meat and the remaining portion is directly sprayed onto the surface of the raw meat.

The raw meat may be treated immediately after slaughter or after subdivision of the meat product prior to chilling, during chilling or after chilling. The raw meat may be removed from the solution or maintained in the solution, for example, where the solution is a marinade or constitutes a part of a marinade in which the meat products are maintained prior to and/or after packaging. Preferably, the pH of the solution applied to the surface or injected or mixed into the meat is between about 4 and 5.8, more preferably between pH 5.4 and 5.8. In a most preferred embodiment, the solution applied to the raw meat has a pH of about 5.6,

While any degree of treatment of the raw meat will result in some improvement in the shelf life and bacterial resistance of the product, preferably treatment results in a meat product that has a pick up of about 0.005% to 2% by weight of the solution, and preferably about 0.1% to about 2%, and more preferably about 0.75% to about 2%. In a preferred embodiment, the treated meat has a pick up of the solution to provide greater than about 0.15% diacetate in the treated product. As used herein, the term “pick up” means the amount of weight gain of the treated meat after treatment, where weight gain equals the finished weight minus the starting weight of the meat product. Percent (%) pick up=weight gain/starting weight×100.

In contrast to prior art methods in which high concentrations of diacetate and citrate are applied to the surface of cooked meat to inhibit bacterial growth, the inventors have discovered that an amount of about 0.2% to about 0.25% by weight of diacetate, acetate or a combination thereof in or on a raw or cooked meat product is sufficient to inhibit the growth of most gram positive bacteria, including Listeria.

### EXAMPLE 1

Storage Stability of Raw Chicken Breast Fillets and Raw Boneless Pork Loin Injected with Marinade Containing a Buffered Sodium Citrate Preparation Containing Sodium Diacetate (Trade Name IONAL Plus)

Chicken breast fillets were obtained from a local chicken processing facility and were from birds slaughtered the same day the meat was picked up. The breast fillets were marinated for 24 hours after receipt at the meat processing laboratory.

The control treatment was meat tumble marinated to 20% pick-up of total marinade using a salt and phosphate marinade that provided a fmal salt content of 1 % and a phosphate content of 0.4% in the marinated product. The IONAL Plus treatment utilized the same salt and phosphate marinade but IONAL Plus was added to a level to provide 0.75% in the marinated product. Breast fillets were packaged three to a bag in Cryovac barrier bags (minimal vacuum just to permit heat sealing of the bags) and stored at 34 to 38° F. in a walk-in cold room. At designated intervals, three bags were taken out, one breast fillet was taken from each bag, and each of the fillets were subjected to microbiological analysis for psychrotrophic aerobic plate count. Each fillet was placed inside a stomacher bag, weighed, 100 mL of sterile 0.1% peptone added, and the sample was placed in the stomacher set at low speed for 1 minute. An aliquot of the wash liquid was then taken, serially diluted, pour plated into TSA medium, and incubated at 30° C. After accounting for the dilution, CFU was divided by the weight of the meat to obtain CFU/g meat.

At each sampling, the headspace gas was sniffed to determine the presence of a sour or putrid smell. In addition, the remaining fillets that were not used for the microbiological analysis were visually examined for slime and smelled to determine if a putrid or sour smell was present.

Boneless pork loins were obtained from a wholesale membership store. The purchased loins were not marinated and were 17 days from slaughter when the meat was purchased. The loins were inject-marinated the same day they were purchased. Marinade pick-up was 12%.

Control marinade was formulated to yield 0.4% salt and 0.35% phosphate in the marinated product. The IONAL Plus treatment comprised the control marinade plus IONAL Plus to yield approximately 0.69% buffered sodium citrate and approximately 0.06% diacetate in the marinated product. After marination, the loin was cut into segments about 4 inches. long and packaged in Cryovac barrier bags (minimal vacuum just to permit heat sealing of the bags), one segment per bag. All samples were stored in a walk-in room cooler at 34-38° F. Three bags from control and three bags from the IONAL Plus-treated meat were taken for microbiological analysis at designated intervals. Each sample was stripped of the packaging material and transferred to a stomacher bag. The packaging material was cut, spread on a template, and the surface area measured. Samples were placed in a stomacher with 100 mL 0.1% peptone and macerated at slow speed for one minute.

An aliquot of the wash liquid was taken, serially diluted and pour plated on TSA medium. Plates were incubated at 30° C. and CFU was counted. After accounting for the dilution, the CFU was divided by the surface area of the meat to obtain CFU/inch². At each sampling time, a package was slit slightly at the top corner and the package was squeezed while the expelled gas was sniffed to determine the presence of a sour or putrid smell. The exposed meat was also examined for slime before transferring to the stomacher bag for microbial analysis. After the stomacher treatment, the meat was retrieved and cut in cross-section to determine if internal discoloration has occurred. Digital pictures of the meat were taken to show discoloration, if present.

The results of the microbiological analyses are shown in Table 1 and Table 2.

TABLE 1
Chicken.

| | Log cfu/g chicken | | | | | | | |
|---|---|---|---|---|---|---|---|---|
| | | | | | IONAL | | | |
| Chicken | Control | | | | Plus | | | |
| Day | min | Max | Average | Std dev | Min. | Max. | Average | Std dev |
| 0 | 2.677 | 2.837 | 2.743 | 0.083 | 2.677 | 2.837 | 2.743 | 0.083 |
| 3 | 3.400 | 4.102 | 3.815 | 0.368 | 3.356 | 3.591 | 3.507 | 0.131 |
| 6 | 5.030 | 5.323 | 5.133 | 0.164 | 3.690 | 4.034 | 3.862 | 0.172 |
| 9 | 5.660 | 6.198 | 5.918 | 0.270 | 3.730 | 4.075 | 3.881 | 0.177 |
| 12 | 6.228 | 6.398 | 6.313 | 0.121 | 4.782 | 5.037 | 4.909 | 0.128 |

| | | | | | |
|---|---|---|---|---|---|
| 15 | Not done | 4.934 | 4.802 | 4.868 | 0.093 |
| 20 | | 4.983 | 4.836 | 4.910 | 0.104 |
| 29 | | 5.683 | 5.829 | 5.756 | 0.103 |

CFU counts and ional treated chicken and pork stored at 3 ± 1° C.

TABLE 2
Pork (CFU/in²)

| | | | | | | | IONAL | | | |
|---|---|---|---|---|---|---|---|---|---|---|
| | | Control | | | | | Plus | | | |
| Day | pH | Min. | Max. | Average | Stdev | pH | Min. | Max. | Average | Stdev |
| 0 | | 3.480 | 4.738 | 4.084 | 0.630 | | 3.480 | 4.738 | 4.084 | 0.630 |
| 3 | | 6.052 | 8.080 | 6.830 | 1.086 | | 4.207 | 5.637 | 4.811 | 0.741 |
| 6 | | 6.897 | 7.586 | 7.139 | 0.388 | | 4.491 | 5.235 | 4.974 | 0.418 |
| 9 | 5.817 | 9.777 | 10.049 | 9.955 | 0.015 | 5.607 | 5.338 | 5.928 | 5.715 | 0.328 |
| 12 | 5.507 | 10.352 | 10.984 | 10.759 | 0.353 | 5.457 | 7.505 | 8.221 | 7.806 | 0.371 |
| 15 | | Spoil | | | | 5.590 | 7.458 | 8.209 | 7.753 | 0.401 |
| 17 | | Spoil | | | | 5.709 | 6.938 | 7.189 | 6.983 | 0.188 |
| 20 | | Spoil | | | | | 6.983 | 8.045 | 7.379 | 0.580 |
| 29 | | Spoil | | | | 5.665 | 8.642 | 9.636 | 9.139 | 0.703 |

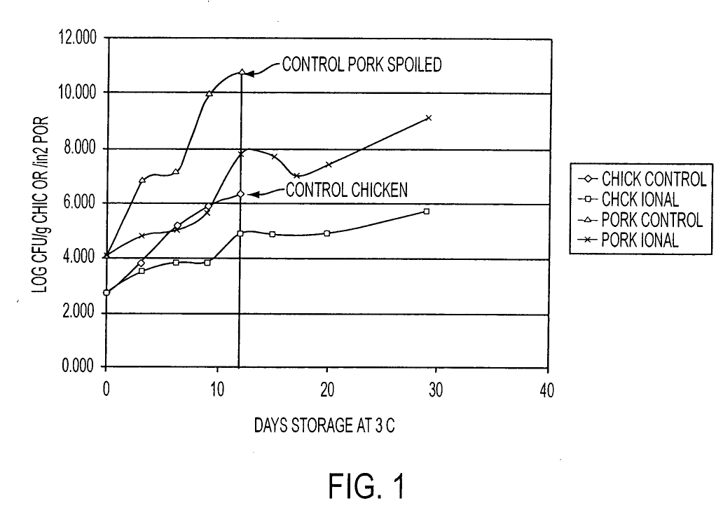

The data on chicken breast fillets show that bacterial counts had reached 10⁶ CFU/g in the control sample by the 12^{th} day of storage. At this point the sample did not show manifestations of spoilage, but the growth curve (FIG. 1) appears to enter the start of the stationary phase where spoilage manifestations usually begin to appear. Our control samples ran out after 12 days. Ional treated chicken breast fillets on the other hand continued to have low CFU counts up to the 29^{th} day of storage. At 29 days, CFU in the ional treated product was less than the CFU in the control at 12 days in storage. Manifestations of spoilage were not observed in any of the chicken samples evaluated at 29 days.

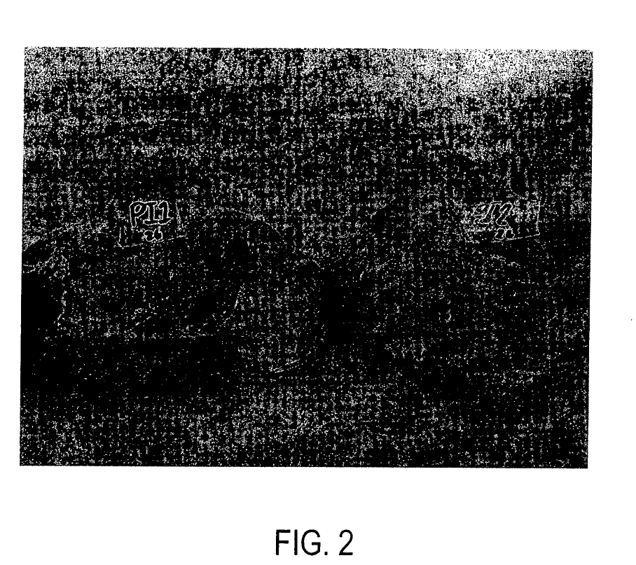

Pork CFU counts were higher than those for chicken. The high surface counts can be attributed partly to the age of the pork at the start of the study, nine days compared to chicken samples which were slaughtered not more than 24 hours before the start of the test. Control pork has started to manifest spoilage on the 12^{th} day of storage. Bacterial count in the control was 10¹⁰ CFU/in² at 12 days in storage. On the 15^{th} day of storage, control samples were definitely spoiled and microbial analysis was not conducted. The IONAL Plus treated samples had counts just slightly over 10⁹ CFU/in² at 29 days of storage and no manifestations of spoilage were exhibited at this time. The storage life of the pork more than doubled with the addition of IONAL Plus in the marinade. Samples ran out after 29 days so the study did not extend to the point where the samples actually spoiled. A picture of the IONAL Plus treated pork (FIG. 2) showed no signs of spoilage and good color retention at 26 days following treatment.

### EXAMPLE 2

Storage Stability of Raw Turkey Breast Injected with a Marinade Containing a Buffered Sodium Citrate Preparation Containing Sodium Diacetate (Trade Name IONAL Plus)

Fresh, raw, boneless, skin-on turkey breasts were injected at 15% with either of two test marinades. Test one marinade contained 5.0% of IONAL PLUS to yield 0.65% of the composition in the treated product. Test two marinade contained 7.5% of IONAL PLUS to yield 0.95% of the composition in the treated meat. The control product was marinated as in Example 1.

The marinated product was packaged in Cryovac barrier bags under full vacuum and placed in a 38° to 42° F. cooler for storage. At predetermined intervals one bag of each test and control was removed and the bacterial count determined.

The results are shown in Table 3.

TABLE 3
Shelf Life Study of Raw Inject Marinated Turkey Breast

| Storage | Control | | Test 1 | | Test 2 | |
|---|---|---|---|---|---|---|
| Time | Core | Wash | Core | Wash | Core | Wash |
| Day 0 (8/5) | | | | | | |
| Day 5 | 1300 | 22,700 | 220 | 1730 | 1320 | 990 |
| (8/10) | | | | | | |
| Day 9 | >125,000 | >1,250,00 | 420 | 2590 | 980 | 1210 |
| (8/14) | | | | | | |
| Day 13 | 102,000 | 1,540,000 | 1270 | 1940 | 370 | 1360 |
| (8/18) | | | | | | |
| Day 15 | 170,000 | 1,740,000 | 2090 | 14,900 | 470 | 1100 |
| (8/20) | | | | | | |
| Day 20 | 640,000 | 5,600,000 | 34,100 | 233,000 | 1170 | 1500 |
| (8/25) | | | | | | |
| Day 22 | 710,000 | 10,800,000 | 14,900 | 214,000 | 840 | 15,100 |
| (8/27) | | | | | | |
| Day 24 | | | 7,000 | 880,000 | 490 | 11,900 |
| (8/29) | | | | | | |
| Day | | | 152,000 | 3,070,000 | 910 | 400 |
| 9/5 | | | 1,250,000 | 9,100,000 | 2,880 | >1,250,000 |
| 9/9 | | | 969,000 | 18,800,000 | 14,200 | 1,440,000 |

Control: 15% Inject, 1% cultured whey
Test 1: 15% Inject, 0.65% IONAL Plus
Test 2: 15% Inject, 0.95% IONAL Plus

### EXAMPLE 3

Storage Stability Data for Inject Marinated Whole Birds

Whole raw chickens were inject marinated with a solution containing salt, phosphate and flavoring and 0.55% Ional Plus or 0.75% Ional Plus. The treated meat was stored at 34° F. (1.1° C.) during the test.

Day two samples were obtained by rinsing a whole chicken with 300 mL 0.1% peptone in a large Cryovac bag and agitating at slow speed in a Stomacher for one minute. Aliquots of liquid were used for aerobic plate count analysis by pour plating in tryptic soy agar.

Day five to 27 samples were obtained by excising several 10 g samples of breast tissue (with skin) adding to 100 mL 0.1% peptone and macerating in a Stomacher for one minute. Aliquots of macerated material were taken for aerobic plate count analysis by pour plating in tryptic soy agar.

Purge was sampled from the bag and directly plated after appropriate dilutions were made CFU's were converted to CFU/g bird or CFU/g tissue. Values are the mean of two determinations.

pH values were from four different points, two on each side of a chicken breast.

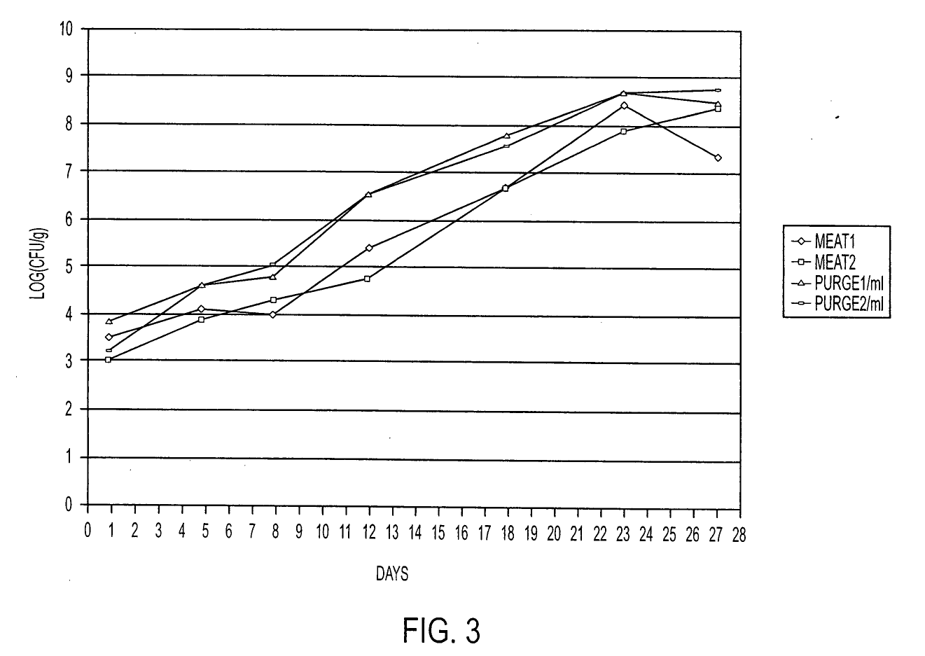

The results are shown in Table 4 and FIG. 3.

TABLE 4
Storage temperature: 34° F. (+/−1.1° C.)
Data: Chicken

| | Meat | Meat | Purge | Meat | Purge |
|---|---|---|---|---|---|
| Day | Sample | log(CFU/g) | log(CFU/ml) | PH | pH |
| 2 | 1 | 3.503 | 3.852 | | |
| 2 | 2 | 2.982 | 3.242 | | |
| 6 | 1 | 4.133 | 4.648 | | |
| 6 | 2 | 3.940 | 4.633 | | |
| 9 | 1 | 4.036 | 4.836 | | |
| 9 | 2 | 4.336 | 5.049 | | |
| 13 | 1 | 5.423 | 6.597 | 6.400 | 6.600 |
| 13 | 2 | 4.781 | 6.550 | 6.123 | 6.700 |
| 19 | 1 | 6.710 | 7.792 | 6.105 | 6.580 |
| 19 | 2 | 6.678 | 7.580 | 5.975 | 6.420 |
| 24 | 1 | 8.450 | 8.699 | | |
| 24 | 2 | 7.878 | 8.728 | | |
| 28 | 1 | 7.375 | 8.531 | 6.192 | 5.881 |
| 28 | 2 | 8.378 | 8.771 | 6.216 | 6.347 |

Formulation 1—Standard marinade with salt, phosphate and flavoring and 0.55% Ional Plus.

Formulation 2—Standard marinade with salt, phosphate and flavoring and 0.75% Ional Plus.

Ional Plus in the marinade generally decreased counts in both the chicken tissue and in the purge, but by less than 0.5 log CFU/g. Both levels of Ional Plus resulted in very long shelf life of at least 19 days.

At 24 days microbial counts exceeded 1 million CFU/g, which indicates adequate numbers to consider them spoiled, but no off-odor or sliminess were manifested in the product.

Counts in the purge paralleled the tissue counts indicating that enough Ional Plus was in the purge to inhibit microbial growth.

pH values were generally higher in Formulation 1 compared to Formulation 2, reflecting the pH lowering effect of Ional Plus. At 28 days, microbial activity may have affected the pH values. Formulation 2-treated meat had a higher pH than Formulation 1-treated meat. Meat treated with Formulation 2 also had higher CFU/g.

1. A method for treating a raw meat product comprising applying onto the surface of and/or in the raw meat product a composition comprising about 50% to about 95% citrate or potassium citrate and about 5% to about 50% diacetate, acetate or a combination thereof.

2. The method of claim 1 wherein the composition comprises about 75% to about 80% buffered citrate and about 20% to about 25% sodium or potassium acetate or sodium or potassium diacetate.

3. The method of claim 2 wherein the composition comprises about 80% buffered citrate and about 20% sodium acetate or sodium diacetate.

4. The method of claim 2 wherein treatment of the meat results in a pick up on and/or in the meat of greater than about 0.15% diacetate by weight.

5. The method of claim 1 wherein the composition is applied as an aqueous solution.

6. The method of claim 1 wherein the composition is applied by spraying an aqueous solution of the composition onto the raw meat, dipping the raw meat into an aqueous solution of the composition, drenching the raw meat with an aqueous solution of the composition, or marinating the raw meat in an aqueous solution comprising the composition.

7. The method of claim 1 wherein the composition has a pH of about 5.6.

8. The method of claim 1 wherein the treated raw meat exhibits more color retention and less purge during storage in comparison to untreated raw meat.

9. A method for extending the storage stability of raw meat comprising treating the raw meat with a composition comprising about 75% to about 80% citrate about 20% to about 25% diacetate, acetate or a combination thereof.

10. The method of claim 9 wherein the composition comprises about 75% to about 80% buffered citrate and about 20% to about 25% sodium or potassium acetate or sodium or potassium diacetate.

11. The method of claim 10 wherein the composition comprises about 80% buffered citrate and about 20% sodium acetate or sodium diacetate.

12. The method of claim 9 wherein treatment of the meat results in a pick up in and/or on the meat of greater than about 0.15% diacetate by weight.

13. The method of claim 9 wherein the composition is applied as an aqueous solution.

14. The method of claim 9 wherein the composition is applied by spraying an aqueous solution of the composition onto the raw meat, dipping the raw meat into an aqueous solution of the composition, drenching the raw meat with an aqueous solution of the composition or marinating the raw meat in an aqueous solution comprising the composition.

15. The method of claim 9 wherein the composition has a pH of about 5.6.

16. The method of claim 9 wherein the treated raw meat exhibits more color retention and less purge during storage in comparison to untreated raw meat.

17. A raw meat product comprising greater than about 0.15% by weight sodium or potassium diacetate, sodium or potassium acetate, or a combination thereof.

18. A composition comprising about 75% to about 80% citrate and about 20% to about 25% sodium acetate, sodium diacetate or a combination thereof.

19. A method for retaining color of raw meat during storage comprising treating the surface of the raw meat with a composition comprising about 50% to about 95% citrate and about 5% to about 50% diacetate, acetate or a combination thereof.

20. The method of claim 19 wherein the composition comprises about 75% to about 80% buffered citrate and about 20% to about 25% sodium or potassium acetate or sodium or potassium diacetate.

21. The method of claim 19 wherein the composition comprises about 80% buffered citrate and about 20 sodium acetate or sodium diacetate.

22. The method of claim 19 wherein treatment of the meat results in a pick up in the meat of greater than about 0.15% diacetate by weight.

23. The method of claim 19 wherein the composition is applied as an aqueous solution.

24. The method of claim 19 wherein the composition is applied by spraying an aqueous solution of the composition onto the raw meat, dipping the raw meat into an aqueous solution of the composition, drenching the raw meat with an aqueous solution of the composition, or marinating the raw mea in an aqueous solution comprising the composition.

25. The method of claim 19 wherein the composition has a pH of about 5.6.

26. A method of reducing purge during storage of raw meat comprising applying a composition comprising about 50% to about 95% sodium citrate or potassium citrate and about 5% to about 50% diacetate, acetate or a combination thereof to the surface of the raw meat.

27. The method of claim 26 wherein the composition comprises about 75% to about 80% buffered citrate and about 20% to about 25% sodium or potassium acetate or sodium or potassium diacetate.

28. The method of claim 26 wherein the composition comprises about 80% buffered citrate and about 20% sodium acetate or sodium diacetate.

29. The method of claim 26 wherein treatment of the meat results in a pick up in the meat of greater than about 0.15% diacetate by weight.

30. The method of claim 26 wherein the composition is applied as an aqueous solution.

31. The method of claim 26 wherein the composition is applied by spraying an aqueous solution of the composition onto the raw meat, dipping the raw meat into an aqueous solution of the composition, drenching the raw meat with an aqueous solution of the composition, or marinating the raw meat in an aqueous solution comprising the composition.

32. The method of claim 26 wherein the composition has a pH of about 5.6.
